(19) United States
(12) Patent Application Publication
(10) Pub. No.: US 2015/0098653 A1
(43) Pub. Date: Apr. 9, 2015

(54) METHOD, ELECTRONIC DEVICE AND STORAGE MEDIUM

(71) Applicant: KABUSHIKI KAISHA TOSHIBA, Tokyo (JP)

(72) Inventor: Aiko Akashi, Akishima-shi (JP)

(73) Assignee: KABUSHIKI KAISHA TOSHIBA, Tokyo (JP)

(21) Appl. No.: 14/257,368

(22) Filed: Apr. 21, 2014

Related U.S. Application Data
(60) Provisional application No. 61/887,749, filed on Oct. 7, 2013.

(51) Int. Cl. G06K 9/00; G06T 3/40; G06F 3/0488

(52) U.S. Cl. CPC G06K 9/00402; G06F 3/04883; G06T 3/40
USPC 382/189

(57) ABSTRACT

According to one embodiment, a method of displaying an image on an electronic device includes acquiring a first image created by a first device comprising a first screen of a first size; and displaying the first image by the electronic device including a second screen of a second size different from the first size. The first image is displayed on the second screen under a first magnification based on the first size and the second size.

### CROSS-REFERENCE TO RELATED APPLICATIONS

This application claims the benefit of U.S. Provisional Application No. 61/887,749, filed Oct. 7, 2013, the entire contents of which are incorporated herein by reference.

### FIELD

Embodiments described herein relate generally to a technique of enlarging an image.

### BACKGROUND

Recently, various electronic devices having a touchscreen display capable of handwriting input, such as a tablet, a personal digital assistant (PDA), a smartphone have been developed.

Conventionally, when an image formed by an electronic device having a large screen is displayed on a small screen of another electronic device, the image is reduced to fall within the small screen of the electronic device. When a user wishes to edit a given portion of the reduced image, he or she had to enlarge the image by means of an operation technique, such as pinch-in and pinch-out and display it, because the reduced image is difficult to edit. This operation is inconvenient to the user; hence, it is required that a new technique be achieved to eliminate the inconvenience.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of the outward appearance of an electronic device according to an embodiment.

FIG. 2 is a block diagram showing an example of association of the electronic device with another device.

FIG. 3 is a sketch showing an example of a document handwritten on a touchscreen display.

FIG. 4 is a chart showing an example of time-series information that is a set of stroke data.

FIG. 5 is a block diagram showing an example of a system configuration of the electronic device.

FIG. 6 illustrates a home screen of the electronic device.

FIG. 7 illustrates a note preview screen of the electronic device.

FIG. 8 illustrates a setting screen of the electronic device.

FIG. 9 illustrates of a page editing screen of the electronic device.

FIG. 10 is a block diagram showing a functional configuration of a handwritten note application program executed by the electronic device.

FIG. 11 illustrates an example in which an image formed by an electronic device having a large screen is displayed on a smaller screen of another electronic device.

FIG. 12 illustrates a rectangular area selected by a range selection module.

FIG. 13 illustrates an example of a screen on which strokes corresponding to a plurality of stroke data items included in the rectangular area are enlarged and displayed.

FIG. 14 illustrates an example of a screen on which strokes corresponding to a plurality of stroke data items included in the rectangular area are enlarged and displayed and the strokes are moved.

FIG. 15 is a flowchart showing an example of an enlargement display process.

### DETAILED DESCRIPTION

Various embodiments will be described hereinafter with reference to the accompanying drawings. In general, according to one embodiment, a method of displaying an image on an electronic device includes acquiring a first image created by a first device comprising a first screen of a first size; and displaying the first image by the electronic device including a second screen of a second size different from the first size. The first image is displayed on the second screen under a first magnification based on the first size and the second size.

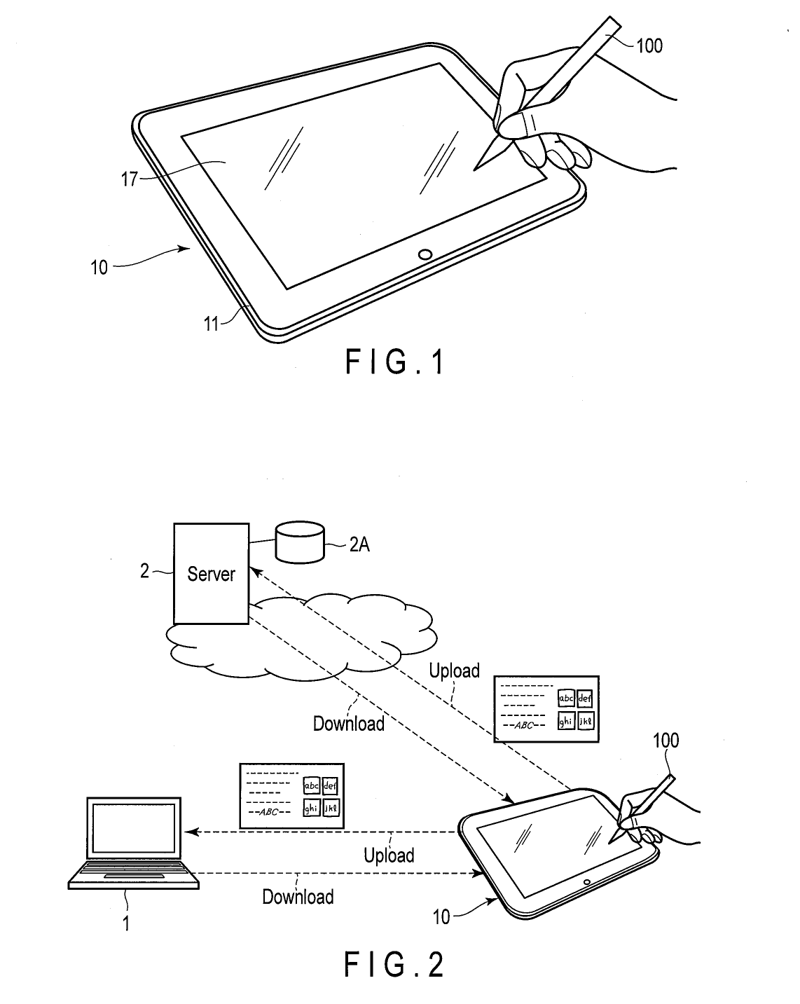

FIG. 1 is a perspective view showing an example of the outward appearance of an electronic device according to an embodiment. The electronic device is, for example, a stylus-based portable electronic device capable of handwriting input with a stylus or a finger. The electronic device may be configured as a tablet computer, a notebook computer, a smartphone, a PDA and the like. Hereinafter, a tablet computer 10 will be described as the electronic device. The tablet computer 10 is called a tablet or a slate computer and includes a main body 11 that is a thin box-shaped housing.

A touchscreen display 17 is mounted on the top surface of the main body 11. The touchscreen display 17 incorporates a flat panel display and a sensor configured to sense a position of a stylus or a finger touched on the screen of the flat panel display. The flat panel display may be configured as a liquid crystal display (LCD), for example. As the sensor, for example, a capacitive touchpanel and an electromagnetic induction type digitizer may be employed. In the following example, the touchscreen display 17 incorporates two different sensors of a digitizer and a touchpanel. Thus, the touchscreen display 17 may be configured to detect a touch on the screen with a stylus 100 as well as a touch on the screen with a finger.

The stylus 100 may be configured as a digitizer stylus (electromagnetic induction stylus). The user is able to perform a handwriting input operation on the touchscreen display 17 using the stylus 100 (in a stylus input mode). In the stylus input mode, a trace of the stylus 100 moving on the screen, or a stroke input by handwriting is obtained; accordingly, a plurality of strokes are input by handwriting and displayed on the screen. A trace of the stylus 100 moving while the stylus 100 is in contact with the screen corresponds to one stroke. The strokes include characters, marks and the like. A set of strokes corresponding to, for example, handwritten characters, handwritten figures, handwritten tables constitute a handwritten page.

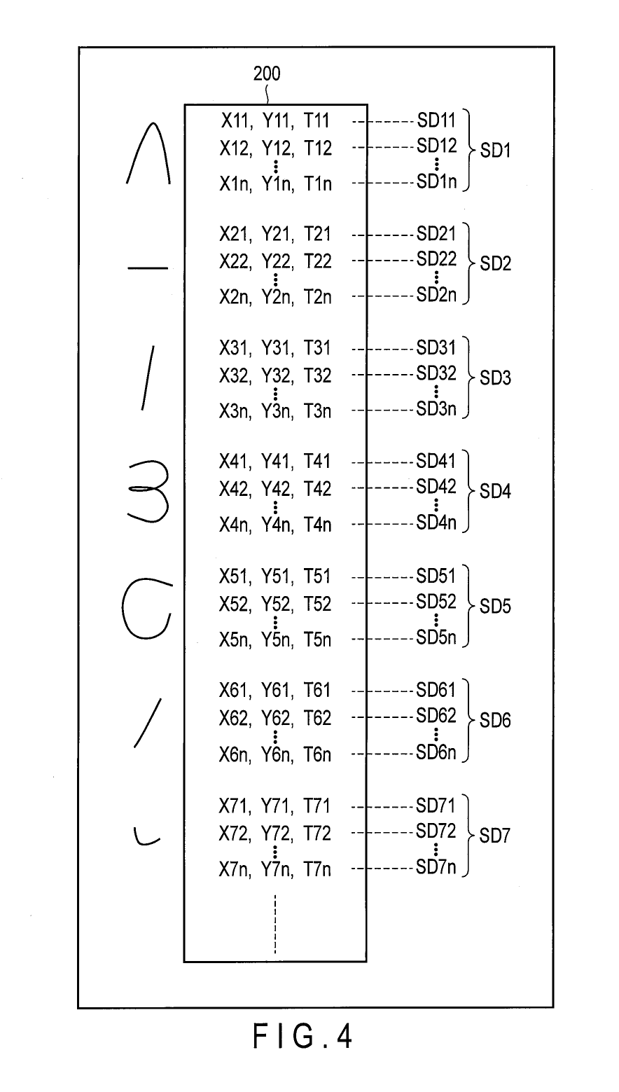

In the embodiment, the handwritten page is not stored in a storage medium as image data but stored in a storage medium as time-series information (handwritten page data) which indicates the relationship in order between the strokes and the coordinates of the traces of the strokes. As will be described in detail later with reference to FIG. 4, the time-series information represents the order in which a plurality of strokes are handwritten and contains a plurality of stroke data items corresponding to the plurality of strokes. In other words, the time-series information means a set of time-series stroke data items corresponding to the plurality of strokes. Each of the stroke data items corresponds to one stroke and includes a coordinate data series (time-series coordinate) which corresponds to each of the points on the trace of the stroke. The order of the stroke data items corresponds to the order in which the strokes are handwritten.

The tablet computer 10 is able to read the existing time-series information out of the storage medium and display on the screen a handwritten page corresponding to the time-series information, or the tablet computer 10 displays a plurality of strokes indicated by the time-series information which are input by handwriting.

Furthermore, the tablet computer 10 operates in a touch input mode for performing a handwriting input operation without using the stylus 100 but with a finger. When the touch input mode is active, the user is able to perform a handwriting operation on the touchscreen display 17 with his or her finger. In the touch input mode, a trace of the finger on the screen, or a stroke input by handwriting is obtained; accordingly, a plurality of strokes are input by handwriting are displayed on the screen.

The tablet computer 10 has an editing function. Using the editing function, the user is able to perform an editing operation using an eraser tool, a range selection tool, and other various tools and delete or move a given handwriting portion (handwritten character, handwritten mark, handwritten figure, handwritten table, etc.) in the handwritten page that is selected by the range selection tool. The handwriting portion in the handwritten page selected by the range selection tool may be designated as a search key for searching for the handwritten page. The handwriting portion may also be subjected to a recognition process, such as handwritten character recognition, handwritten figure recognition and handwritten table recognition.

FIG. 2 shows an example of association of the tablet computer 10 with an external device. The tablet computer 10 includes a wireless communication device, such as a wireless local area network (LAN). The tablet computer 10 may carry out wireless communication with a personal computer 1. Furthermore, the tablet computer 10 is able to carry out communication with a server 2 on the Internet 3 using the wireless communication device. The server 2 may be configured to perform an on-line storage service and other cloud computing services.

The personal computer 1 includes a storage device, such as a hard disk drive (HDD). The tablet computer 10 is able to transmit time-series information (handwritten document data) to the personal computer 1. The information is stored in the HDD of the personal computer 1 (upload). In order to maintain secure communications between the tablet computer 10 and the personal computer 1, the personal computer 1 may authenticate the tablet computer 10 at the start of communication. In this case, a dialog may be displayed on the screen of the tablet computer 10 to prompt a user to input an ID or a password and, for example, an ID of the tablet computer 10 may automatically be transmitted to the personal computer 1.

Therefore, the tablet computer 10 is able to handle a large amount of time-series information even though the storage capacity of the tablet computer 10 is small.

The destination with which the tablet computer 10 communicates need not be the personal computer 1 but may be the server 2 on the cloud computing that provides a storage service or the like, as described above. The tablet computer 10 is able to transmit the time-series information (handwritten page data) to the server 2 via the Internet. The information is stored in a storage device 2A of the server 2 (upload). The tablet computer 10 is also able to read arbitrary time-series information out of the storage device 2A of the server 2 (download) and display a trace of each of the strokes indicated by the time-series information on the screen of the display 17.

As described above, in the present embodiment, the time-series information may be stored in the storage device in the tablet computer 10, the storage device in the personal computer 1 or the storage device in the server 2.

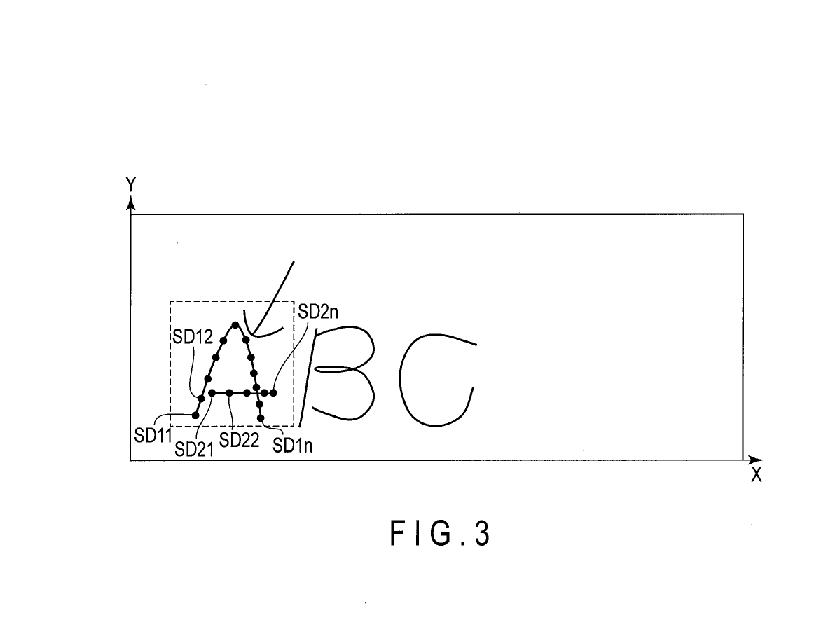

The relationship between user's handwritten strokes (characters, figures, tables, etc.) and time-series information will be described with reference to FIGS. 3 and 4. FIG. 3 illustrates an example of a handwritten page (handwritten character string) on the touchscreen display 17 with the stylus 100 or the like.

In most handwritten pages, for example, on a character or a figure input by handwriting, another character or another figure is input by handwriting. In FIG. 3, letters “A,” “B” and “C” are input by handwriting in this order and then an arrow is input by handwriting close to the handwritten letter “A”.

The handwritten letter “A” is represented by two strokes (A and Λ) handwritten with the stylus 100 or the like, namely, two traces. The trace of the stylus 100 for the first handwritten stroke “Λ” is sampled at regular time intervals in real time; accordingly, time-series coordinates SD11 to SD1n of the stroke “Λ” are obtained. Similarly, the trace of the stylus 100 for the next handwritten stroke “-” is also sampled at regular time intervals in real time; accordingly, time-series coordinates SD21 to SD2n of the stroke “-” are obtained.

The handwritten letter “B” is represented by two strokes handwritten with the stylus 100 or the like, namely, two traces. The handwritten letter “C” is represented by one stroke handwritten with the stylus 100 or the like, namely, one trace. The handwritten arrow is represented by two strokes handwritten with the stylus 100 or the like, namely, two traces.

FIG. 4 shows time-series information 200 corresponding to the handwritten page shown in FIG. 3. The time-series information includes a plurality of stroke data items SD1 to SD7. In the time-series information 200, these stroke data items SD1 to SD7 are arranged in time series in the order that their corresponding strokes are handwritten.

The initial two stroke data items SD1 and SD2 in the time-series information 200 indicate two strokes of the handwritten letter “A”. The third and fourth stroke data items SD3 and SD4 indicate two strokes of the handwritten letter “B”. The fifth stroke data item SD5 indicates one stroke of the handwritten letter “C”. The sixth and seventh stroke data items SD6 and SD7 indicate two strokes of the handwritten arrow.

Each of the stroke data items includes a coordinate data series (time-series coordinates) which corresponds to one stroke, or a plurality of coordinates which correspond to a plurality of sampling points on the trace of one stroke. In each of the stroke data items, the coordinates of the sampling points are arranged in time series in the order that the strokes are handwritten (sampled). With respect to the handwritten letter “Λ”, for example, the stroke data item SD1 includes a coordinate data series (time-series coordinates) which corresponds to the points on the trace of the handwritten stroke “Λ”, or n coordinate data items SD11 to SD1n. The stroke data item SD2 includes a coordinate data series which corresponds to the points on the trace of the handwritten stroke “-”, or n coordinate data items SD21 to SD2n. The number n of coordinate data items may be varied from stroke data to stroke data. If the strokes are each sampled at regular time intervals, they differ in sampling points because they differ in length.

Each coordinate data item represents X and Y coordinates of one point in a trace corresponding to the coordinate data item. For example, the coordinate data item SD11 represents the X coordinate (X11) and Y coordinate (Y11) at the beginning of the stroke “Λ”. The coordinate data item SD1n represents the X coordinate (X1n) and Y coordinate (Y1n) at the end of the stroke “Λ”.

Each coordinate data item may include time stamp information T corresponding to a point in time (sampling timing) when its corresponding point is handwritten. The point in time may be an absolute time (for example, second/minute/hour/day/month/year) or a relative time which is based upon a certain point in time. For example, an absolute time (for example, second/minute/hour/day/month/year) when a stroke starts to be written may be added to each stroke data item as time stamp information, and a relative time indicative of a difference between the absolute time and the relative time may be added to the coordinate data of each stroke data item as time stamp information.

Using time-series information to which the time stamp information T is added is used in each of the coordinate data items, as described above, the temporal relationship between strokes may be represented more precisely. Though not shown in FIG. 4, information (Z) indicative of writing pressure may be added to each of the coordinate data items.

The time-series information 200 having a structure as described with respect to FIG. 4 is able to represent a temporal relationship between strokes as well as handwriting of each stroke. Using the time-series information 200, the handwritten letter “A” and the tip of the handwritten arrow may be processed as different characters or different figures even though the tip of the handwritten arrow is written to overlap the handwritten letter “A” or written close thereto, as shown in FIG. 3.

In the present embodiment, as described above, the handwritten page data is not stored as an image or a result of character recognition but as the time-series information 200 that is composed of a set of time-series stroke data items. Accordingly, handwritten characters may be processed without relying upon the language of the handwritten characters. Therefore, the structure of the time-series information 200 may be shared among various countries in which different languages are used.

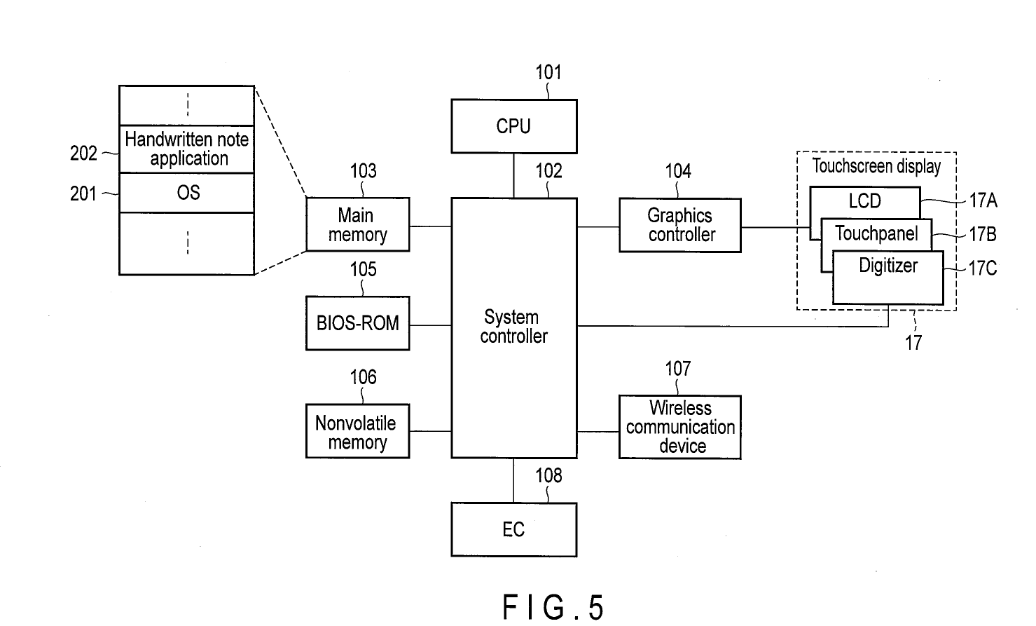

FIG. 5 is a block diagram showing a system configuration of the tablet computer 10.

The tablet computer 10 includes a central processing unit (CPU) 101, a system controller 102, a main memory 103, a graphics controller 104, a BIOS-ROM 105, a nonvolatile memory 106, a wireless communication device 107, an embedded controller (EC) 108 and the like.

The CPU 101 is a processor that controls the operations of various modules in the tablet computer 10. The nonvolatile memory 106 is a storage device. The CPU 101 executes various software programs that are loaded into the main memory 103 from the nonvolatile memory 106. The software programs include an operating system (OS) 201 and various application programs. The application programs include a handwritten note application program 202. The handwritten note application program 202 has a function of creating and displaying the handwritten document data, a function of editing the handwritten document data and a function of searching for handwritten document data including a desired portion or a desired portion of handwritten document data. The handwritten note application program 202 also has a function of adjusting a display magnification to display handwritten document data, which was created by a tablet computer, on the screen of another tablet computer which differs in size from the screen of the former tablet computer.

The CPU 101 also executes a basic input/output system (BIOS) stored in the BIOS-ROM 105. The BIOS is a program for hardware control.

The system controller 102 is a device for connecting the local bus of the CPU 101 and various component modules. The system controller 102 includes a memory controller which controls access to the main memory 103. The system controller 102 has a function of communicating with the graphics controller 104 via a serial bus of the PCI EXPRESS standard or the like.

The graphics controller 104 is a display controller which controls an LCD 17A used as a display monitor of the tablet computer 10. The graphics controller 104 generates a display signal and transmits it to the LCD 17A. The LCD 17A displays a screen image in response to the display signal. The LCD 17A, touchpanel 17B and digitizer 17C overlap one another. The touchpanel 17B is a pointing device of a capacitance type for inputting data on the screen of the LDC 17A. The touchpanel 17B is configured to detect a touched position of a user's finger on the screen, a movement of the touched position and the like. The digitizer 17C is also a pointing device of an electromagnetic induction type for inputting data on the screen of the LCD 17A. The digitizer 17C is configured to detect a touched position of the stylus (digitizer stylus) 100 on the screen, a movement of the touched position and the like.

The wireless communication device 107 is a device configured to carry out wireless communications, such as wireless LAN communication and 3G mobile communication. The EC 108 is a one-chip microcomputer including an embedded controller for power management. The EC 108 has a function of powering on or powering off the tablet computer 10 in accordance with a user's operation of a power button.

Below are some typical examples of a screen presented to a user by the handwritten note application program 202.

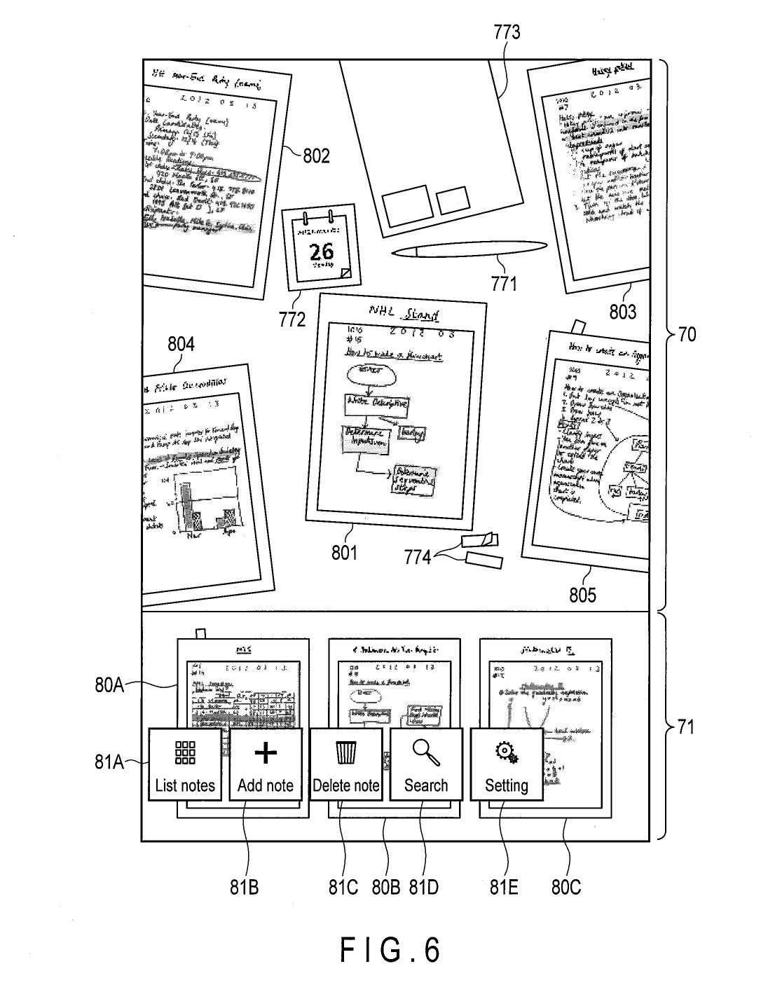

FIG. 6 shows an example of the home screen of the handwritten note application program 202. The home screen is a basic screen for handling a plurality of items of handwritten page data and is capable of managing a note and setting the entire application.

The home screen includes a desktop screen area 70 and a drawing screen area 71. The desktop screen area 70 is a temporary area for displaying note icons 801 to 805 corresponding to active handwritten notes. Each of the note icons 801 to 805 indicates a thumbnail of a page in its corresponding handwritten note. The desktop screen area 70 displays a stylus icon 771, a calendar icon 772, a scrap note (gallery) icon 773 and a tag (label) icon 774.

The stylus icon 771 is a graphical user interface (GUI) for switching the display screen from the home screen to a page editing screen. The calendar icon 772 is an icon for indicating the present date. The scrap note icon 773 is a GUI for browsing a data (scrap data or gallery data) which is captured from another application program or an external file. The tag icon 774 is a GUI for labeling (tagging) an arbitrary page in an arbitrary handwritten note.

The drawing screen area 71 is a display area for browsing a storage area for storing all the prepared handwritten notes. The drawing screen area 71 displays note icons 80A, 80B and 80C corresponding to some of the handwritten notes. The handwritten note application program 202 is able to detect a gesture (for example, a swipe) on the drawing screen area 71, which is made by the user with his or her finger or the stylus 100. When the gesture (for example, a swipe) is detected, the handwritten note application program 202 scrolls a screen image on the drawing screen area 71 in the left or right direction. Thus, a note icon corresponding to an arbitrary handwritten note may be displayed on the drawing screen area 71.

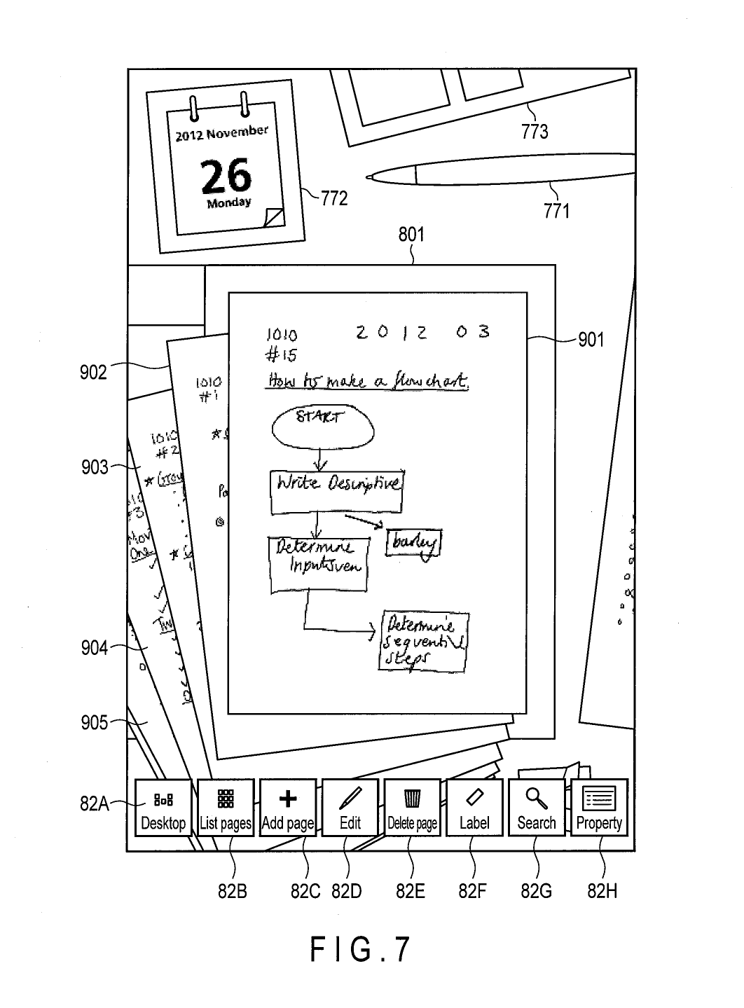

The handwritten note application program 202 is able to detect another gesture (for example, a tap) on a note icon of the drawing screen area 71, which is made by the user with his or her finger or the stylus 100. When the gesture (for example, a tap) is detected, the handwritten note application program 202 moves the note icon to the central part of the desktop screen area 70. Then, the handwritten note application program 202 selects a handwritten note corresponding to the note icon and displays a note preview screen shown in FIG. 7 in place of the desktop screen. The note preview screen shown in FIG. 7 is a screen which allows an arbitrary page in the selected handwritten note to be browsed.

Furthermore, the handwritten note application program 202 is also able to detect a gesture (for example, a tap) on the desktop screen area 70, which is made by the user with his or her finger or the stylus 100. When the gesture (for example, a tap) on the note icon, which is located in the central part of the desktop screen area 70, is detected, the handwritten note application program 202 selects a handwritten note corresponding to the note icon and then displays the note preview screen shown in FIG. 7 in place of the desktop screen.

Moreover, the home screen is able to display a menu. The menu includes a note list button 81A, a note creation button 81B, a note deletion button 81C, a search button 81D and a setting button 81E on its lower part, such as the drawing screen area 71. The note list button 81A is a button for displaying a list of handwritten notes. The note creation button 81B is a button for creating (adding) a new handwritten note. The note deletion button 81C is a button for deleting a handwritten note. The search button 81D is a button for opening a search screen (search dialog). The setting button 81E is a button for opening a setting screen of an application.

Though not shown, a return button, a home button and a recent application button are displayed under the drawing screen area, too.

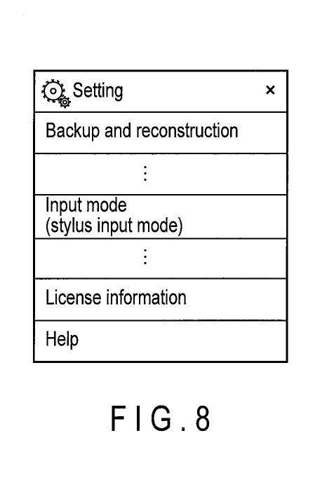

FIG. 8 shows an example of a setting screen that is opened when a user taps the setting button 81E with his or her finger or the stylus 100.

The setting screen displays various setting items. The setting items include “backup and reconstruction,” “input mode (stylus or touch input mode),” “license information,” “help” and the like.

When the user taps the note creation button 81B with his or her finger or the stylus 100 on the home screen, the note creation screen is displayed. The user inputs the name of a note to a title field of the note creations screen by handwriting. The user may choose the front cover and sheet of the note. When the user depresses the creation button, a new note is created and the created note is placed on the drawing screen area 71.

FIG. 7 shows an example of the above note preview screen.

The note preview screen is a screen which allows an arbitrary page in the selected handwritten note to be browsed. Here is a description of a case where a handwritten note is selected to correspond to the note icon 801 of the desktop screen area 70 of the home screen. In this case, the handwritten note application program 202 displays a plurality of pages 901, 902, 903, 904 and 905 included in the handwritten note in such a manner that at least part of each of these pages may be viewed and these pages overlap each other.

Furthermore, the note preview screen displays the above-described stylus icon 771, calendar icon 772 and scrap note icon 773.

The note preview screen is also able to display a menu on its lower part. This menu includes a home button 82A, a page list button 82B, a page addition button 82C, a page editing button 82D, a page deletion button 82E, a label button 82F, a search button 82G and a property display button 82H. The home button 82A is a button for closing a note preview and displaying a home screen. The page list button 82B is a button for displaying a list of pages in the currently selected handwritten note. The page addition button 82C is a button for creating (adding) a new page. The editing button 82D is a button for displaying a page editing screen. The page deletion button 82E is a button for deleting a page. The label button 82F is a button for displaying a list of available various labels. The search button 82G is a button for displaying a search screen. The property display button 82H is a button for displaying property of the note.

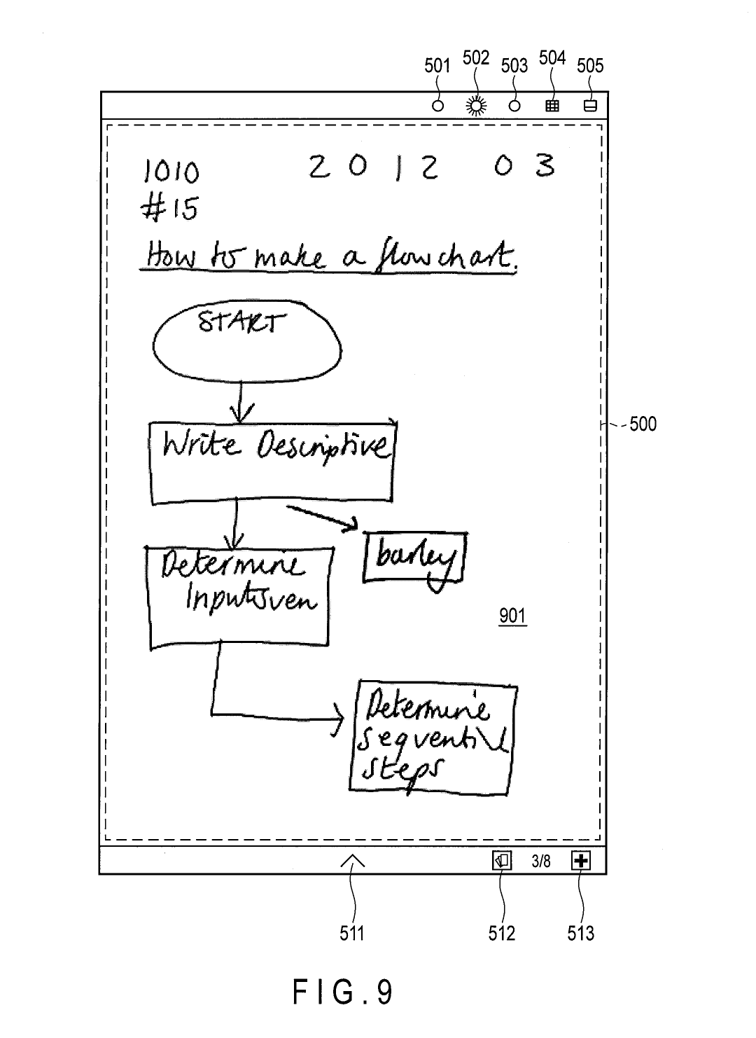

The handwritten note application program 202 is able to detect user's various gestures on the note preview screen. For example, upon detecting a gesture, the handwritten note application program 202 changes the top page to a given page (page skip and page return). Upon detecting a gesture (for example, a tap) on the top page, a gesture (for example, a tap) on the stylus icon 771 or a gesture (for example, a tap) on the editing button 82D, the handwritten note application program 202 selects the top page and displays the page editing screen shown in FIG. 9 in place of the note preview screen.

The editing screen shown in FIG. 9 is a screen capable of making a new page (handwritten page) in the handwritten note and browsing and editing the existing page. When page 901 is selected on the note preview screen shown in FIG. 7, the page editing screen displays the contents of page 901, as shown in FIG. 9.

In the page editing screen, a rectangular area surrounded by broken lines is a handwritten input area 500. In the handwritten input area 500, an input event from the digitizer 17C is used to display (draw) a handwritten stroke and not as an event indicating a gesture, such as a tap. In the area other than the handwritten input area 500 in the page editing screen, an input event from the digitizer 17C may be used as an event indicating a gesture, such as a tap.

An input event from the touchpanel 17B is not used to display (draw) a handwritten stroke but as an event indicating a gesture, such as a tap and a swipe.

Furthermore, a quick-select menu including three different pens 501 to 503, a range selection pen 504 and an eraser pen 505, which are preregistered by a user, is displayed on the upper part of the page editing screen, excluding the handwritten input area 500. Here, of the pens 501 to 503, a black pen 501, a red pen 502 and a marker 503 are preregistered by the user. The user is able to tap a pen (button) in the quick-select menu with his or her finger or the stylus 100 to select the type of pen to be used. If the black pen 501 is selected by the user tapping with a finger or the stylus 100 and the user carries out a handwriting input operation on the page editing screen with the stylus 100, the handwritten note application program 202 displays a black stroke (trace) on the page editing screen in agreement with the movement of the stylus 100.

A desired pen may be selected from the above three different pens in the quick-select menu by operating a side button (not shown) of the stylus 100. A combination of the color and thickness of a commonly-used pen may be set to each of the three different pens in the quick-select menu.

Furthermore, a menu button 511, a page return (return to the note preview screen) button 512 and a new page addition button 513 are displayed on the lower part of the page editing screen, excluding the handwritten input area 500. The menu button 511 is a button for displaying a menu.

The menu may include buttons for dragging a page into the recycle bin (trash can), copying or cutting and pasting part of a page, opening the search screen, displaying an export sub-menu, displaying an import sub-menu, converting a page into text and mailing the text, displaying a pen case and the like. The export sub-menu causes the user to choose, for example, a function of recognizing a handwritten page displayed on the page editing screen and converting it into an electronic document, a presentation file, an image file or the like, or a function of converting a page into an image file and sharing it with another application. The import sub-menu causes the user to choose, for example, a function of importing a memo from a memo gallery, or a function of importing an image from the gallery. The pen case is a button for calling a pen setting screen capable of selecting a color (a color of a drawn line) and a thickness (a thickness of a drawn line) of each of the three different pens in the quick-select menu.

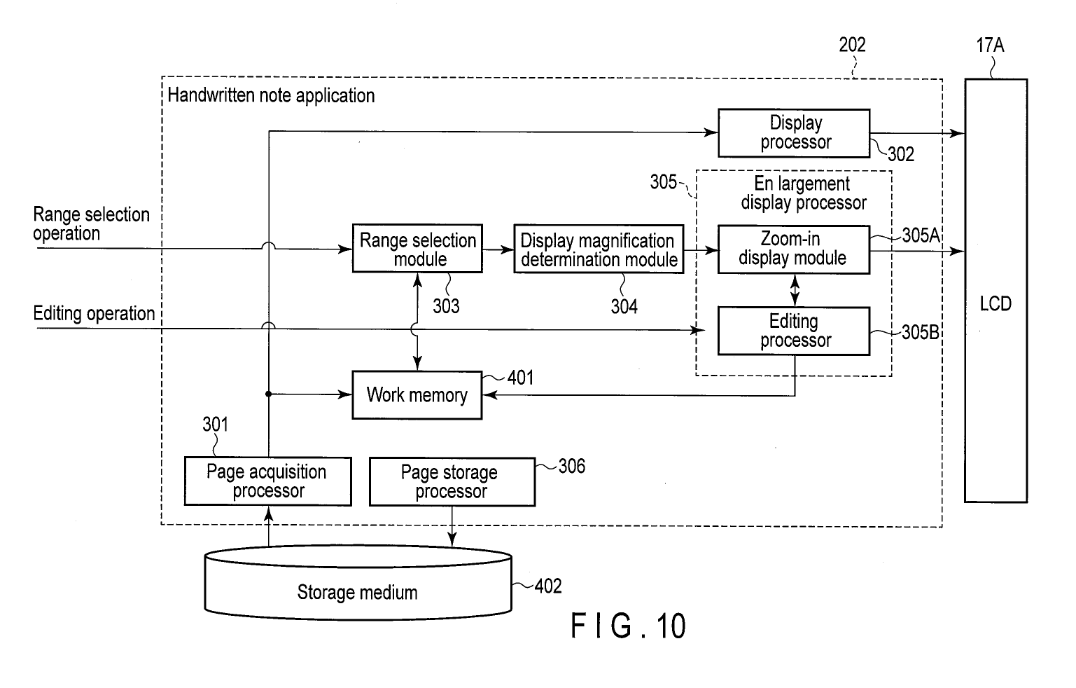

A functional configuration of the handwritten note application program 202 will be described below with reference to FIG. 10.

The handwritten note application program 202 is a WYSIWYG application capable of handling handwritten page data. As shown in FIG. 10, the handwritten note application program 202 includes a page acquisition processor 301, a display processor 302, a range selection module 303, a display magnification determination module 304, an enlargement display processor 305, a page storage processor 306, a work memory 401 and the like. The enlargement display processor 305 includes an enlargement display module 305A and an editing processor 305B.

The touchpanel 17B is configured to detect an occurrence of an event, such as “touch”, “slide” and “release”. The “touch” is an event indicating that an object (a finger) touches the screen. The “slide” is an event indicating that an object (a finger) that is touching the screen moves. The “release” is an event indicating that an object (a finger) is released from the screen.

The digitizer 17c is also configured to detect an occurrence of an event, such as “touch”, “slide” and “release”. The “touch” is an event indicating that an object (stylus 100) touches the screen. The “slide” is an event indicating that an object (stylus 100) that is touching the screen moves. The “release” is an event indicating that an object (stylus 100) is released from the screen.

For the sake of brevity, it is assumed that the stylus 100 is an object in the following descriptions.

The handwritten note application program 202 displays a page editing screen for creating, browsing and editing handwritten page data on the touchscreen display 17. In the present embodiment, the principal function of the handwritten note application program 202 is to display the page editing screen on the touchscreen display 17.

As will be described in detail later, the range selection module 303 and editing processor 305B receive an event of “touch”, “slide” or “release” generated by the digitizer 17C to detect a handwritten input operation. The event of “touch” includes the coordinates of a touched position. The event of “slide” includes the coordinates of a touched position of a slide destination. Thus, the range selection module 303 and editing processor 305B are able to receive (input) a coordinate series (or stroke data) which corresponds to the trace of movement of a touched position from the digitizer 17C.

The page acquisition processor 301 acquires arbitrary handwritten page data from a storage medium 402. In the present embodiment, the page acquisition processor 301 acquires not handwritten page data created by the tablet computer 10 but handwritten page data created by another tablet computer (an external device) whose screen differs in size from the tablet computer 10. The tablet computer that creates handwritten page data may be referred to as a first device having a first screen of a first size, and the tablet computer that displays handwritten page data may be referred to as a second device having a second screen of a second size various from the first size. The handwritten page data includes a plurality of stroke data items, as described with reference to FIGS. 3 and 4. The handwritten page data also includes screen size data indicating the screen size (for example the number of inches) of a tablet computer that creates the handwritten page data. The acquired handwritten page data is transmitted to the display processor 302 and work memory 401. The handwritten page data may be referred to as a first image.

The display processor 302 displays on the screen a plurality of strokes corresponding to the plurality of stroke data items included in the handwritten page data.

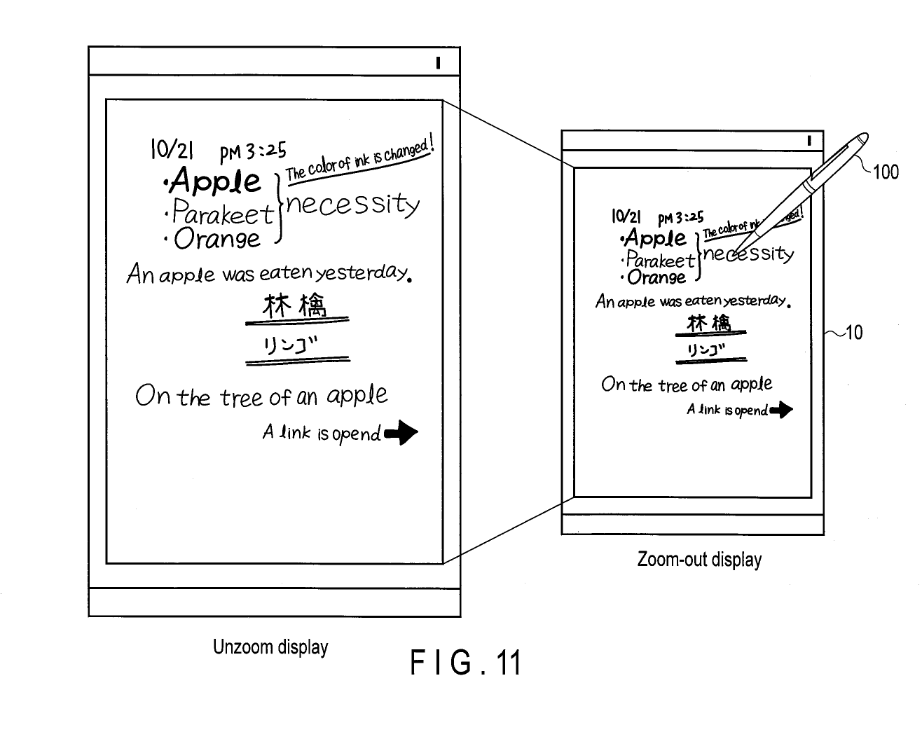

An example of a screen in which handwritten page data is displayed by a tablet computer whose screen size is smaller than that of a tablet computer that creates the handwritten page data, will be described with reference to FIG. 11.

FIG. 11 shows an example of a screen in which handwritten page data is displayed by a tablet computer whose screen size is smaller than that of a tablet computer that creates the handwritten page data. FIG. 11 shows on its left side an example of a screen in which handwritten page data is displayed in an unmagnified manner by the tablet computer that creates the handwritten page data. FIG. 11 shows on its right side an example of a screen in which the handwritten page data created by the left-side tablet computer is displayed by the tablet computer 10 whose screen size is smaller than that of the left-side tablet computer. If, as shown in FIG. 11, the strokes corresponding to all of the stroke data items included in the handwritten page data created by the tablet computer whose screen size is larger, are displayed by the tablet computer 10 whose screen size is smaller, they will be displayed in a reduced manner.

Though not described in detail here, like the range selection module 303 and editing processor 305B, the display processor 302 may receive various events from the digitizer 17C to detect a handwritten input operation. Accordingly, the display processor 302 displays handwritten strokes on the screen in accordance with the movement of the stylus 100 on the screen detected with the digitizer 17C. Thus, the trace of the stylus 100 that is in touch with the screen, or the trace of each of the strokes may be displayed on the page editing screen.

When the digitizer 17C detects that the stylus 100 touches or hovers over the screen, the range selection module 303 acquires the currently-displayed handwritten page data from the work memory 401. Then, the range selection module 303 determines whether the screen size indicated by the screen size data included in the acquired handwritten page data is larger than that of the tablet computer 10. The screen size data indicating the screen size of the tablet computer 10 is managed by the OS 201, and the range selection module 303 is able to acquire the screen size data from the OS 201 when necessary.

When the range selection module 303 determines that the screen size indicated by the screen size data included in the acquired handwritten page data is larger than that of the tablet computer 10, it determines whether the stylus 100 has moved or not. More specifically, it determines whether the stylus 100 has moved by a given amount during a threshold period of time. If the digitizer 17C detects that the stylus 100 has moved by not smaller than a given amount during a preset threshold period of time, the range selection module 303 determines that the stylus 100 has moved. If the digitizer 17C does not detect it to the contrary, the range selection module 303 determines that the stylus 100 stops.

When the range selection module 303 determines that the stylus 100 stops, it selects a given rectangular area, the center of which corresponds to the tip of the stylus 100 detected by the digitizer 17C, as an area the display magnification of which is to be changed.

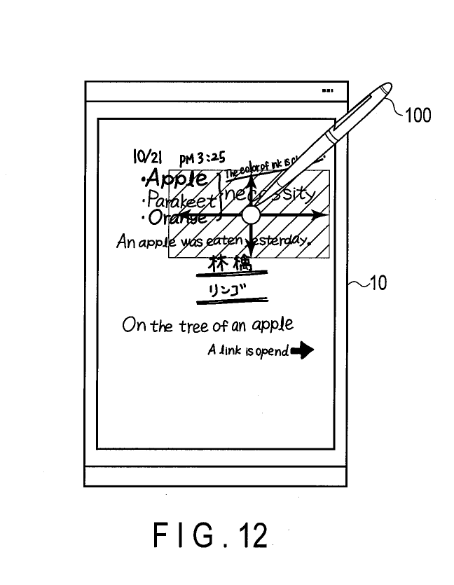

The above rectangular area will be described with reference to FIG. 12.

FIG. 12 shows a rectangular area selected by the range selection module 303. To select a rectangular area, the range selection module 303 receives a detection signal from the digitizer 17C. The detection signal includes coordinate information (X, Y) of a touched position. More specifically, upon receiving the detection signal, the range selection module 303 is able to acquire coordinate information (X, Y) indicative of a position of the tip of the stylus 100 detected by the digitizer 17C. Accordingly, the range selection module 303 selects a given rectangular area (corresponding to the hatching of FIG. 12), which is defined by shifting the acquired coordinate information (X, Y) in each of the vertical and horizontal directions by a given amount, as an area the display magnification of which is to be changed. In the present embodiment, the range selection module 303 selects a given rectangular area; however, it may select a circular area, an ellipsoid area, or the like.

The display magnification determination module 304 determines (adjusts) a display magnification (enlargement magnification) of a rectangular area selected by the range selection module 303 on the basis of the screen size indicated by the screen size data included in the handwritten page data and the screen size of the tablet computer 10. For example, the display magnification determination module 304 may be configured to determine an enlargement magnification of the rectangular area on the basis of the ratio of the screen size indicated by the screen size data included in the handwritten page data to the screen size of the tablet computer 10. As an example, when the screen size indicated by the screen size data included in the handwritten page data is 10 inches and the screen size of the tablet computer 10 is 7 inches, the enlargement magnification of the rectangular area may be set to the ratio of 10 to 7. Below are other methods for determining a zoon-in magnification of the above rectangular area.

(1) A method of determining an enlargement magnification on the basis of the ratio of two screen sizes in the same manner as described above when a difference in screen size is smaller than a preset threshold value and determining an enlargement magnification as a given fixed value (maximum enlargement magnification) when the difference is larger than the preset threshold value; and

(2) A method of determining an enlargement magnification so as to exhibit a relationship between a difference in screen size and an enlargement magnification, which is similar to a logarithmic function, in which the range of the enlargement-magnification increases until the difference in screen size exceeds a predetermined value and it decreases when the difference in screen size exceeds the predetermined value.

The enlargement display processor 305 enlarges a plurality of strokes included in the above rectangular area under the display magnification determined by the display magnification determination module 304 and displays them.

The enlargement display processor 305 shown in FIG. 10 will be described in detail below.

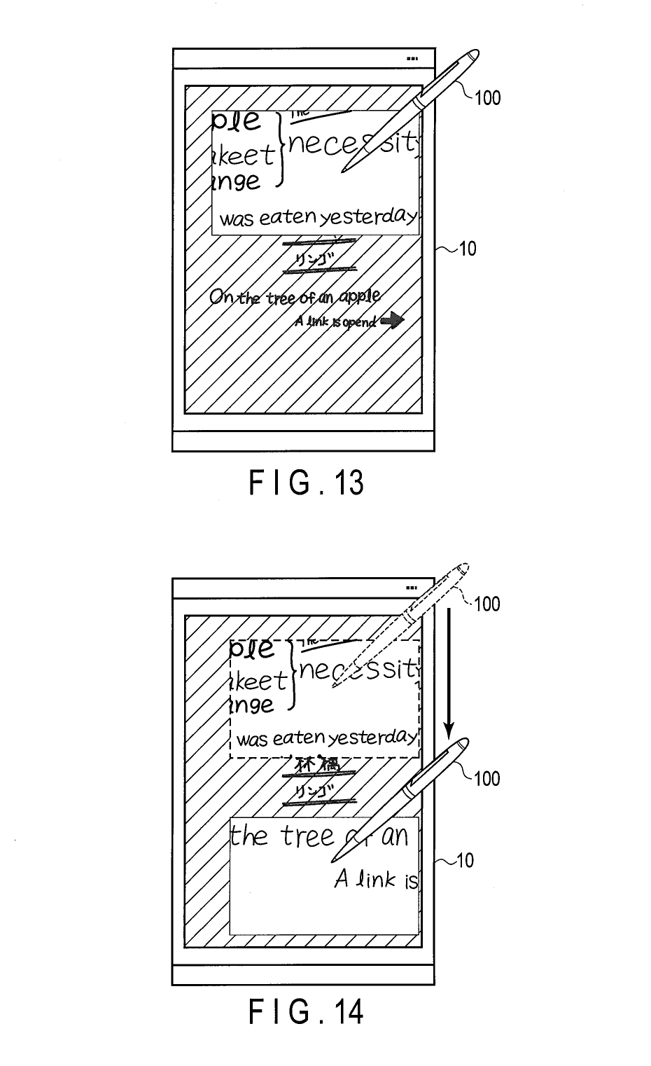

As illustrated in FIG. 13, the enlargement display module 305A enlarges the strokes included in the rectangular area under the display magnification determined by the display magnification determination module 304 and displays them on the screen. In the screen shown in FIG. 13, the strokes included in the rectangular area are zoomed in and pop-up displayed on the screen. The method of displaying the strokes included in the rectangular area and displaying them on the screen is not limited to pop-up display but, for example, only the zoomed-in strokes may be displayed on the screen. The display frame that is pop-up displayed by the enlargement display module 305A may be moved in agreement with the movement of the stylus 100 detected by the digitizer 17C, as shown in FIG. 14.

If the digitizer 17C detects that the stylus 100 has moved by not smaller than a given amount during a preset threshold period of time, the enlargement display module 305A maintains (fixes) the display magnification of the rectangular area under the display magnification (first display magnification) after enlargement for a given period of time (first period of time). If not to the contrary, the enlargement display module 305A returns the display magnification of the rectangular area to the original display magnification. Even though the enlargement display module 305A maintains the display magnification of the rectangular area during a preset threshold period of time, if the digitizer 17C does not detect that the stylus 100 has moved by not smaller than a given amount after the preset threshold period of time, the enlargement display module 305A returns the display magnification of the rectangular area to the original display magnification.

The editing processor 305B performs a process for editing a handwritten page in the pop-up displayed rectangular area. More specifically, the editing processor 305B performs an editing process including a process for adding a new stroke (for example, a new handwritten character and a new handwritten mark) to the handwritten page in the pop-up displayed rectangular area and a process for deleting or moving at least one of the strokes that is being displayed, in accordance with a user's editing operation and handwriting input operation on the touchscreen display 17. Furthermore, the editing processor 305B updates time-series information in the work memory 401 in order to reflect a result of the editing process in the time-series information that is being displayed. The editing processor 305B simply updates the time-series information included in the handwritten page data and does not update the screen size data included in the handwritten page data.

The page storage processor 306 stores in the storage medium 402 handwritten page data including a plurality of stroke data items corresponding to a plurality of handwritten strokes on the handwritten page in preparation or editing. The storage medium 402 may be configured as a storage device in the tablet computer 10 or a storage device in the server computer 2.

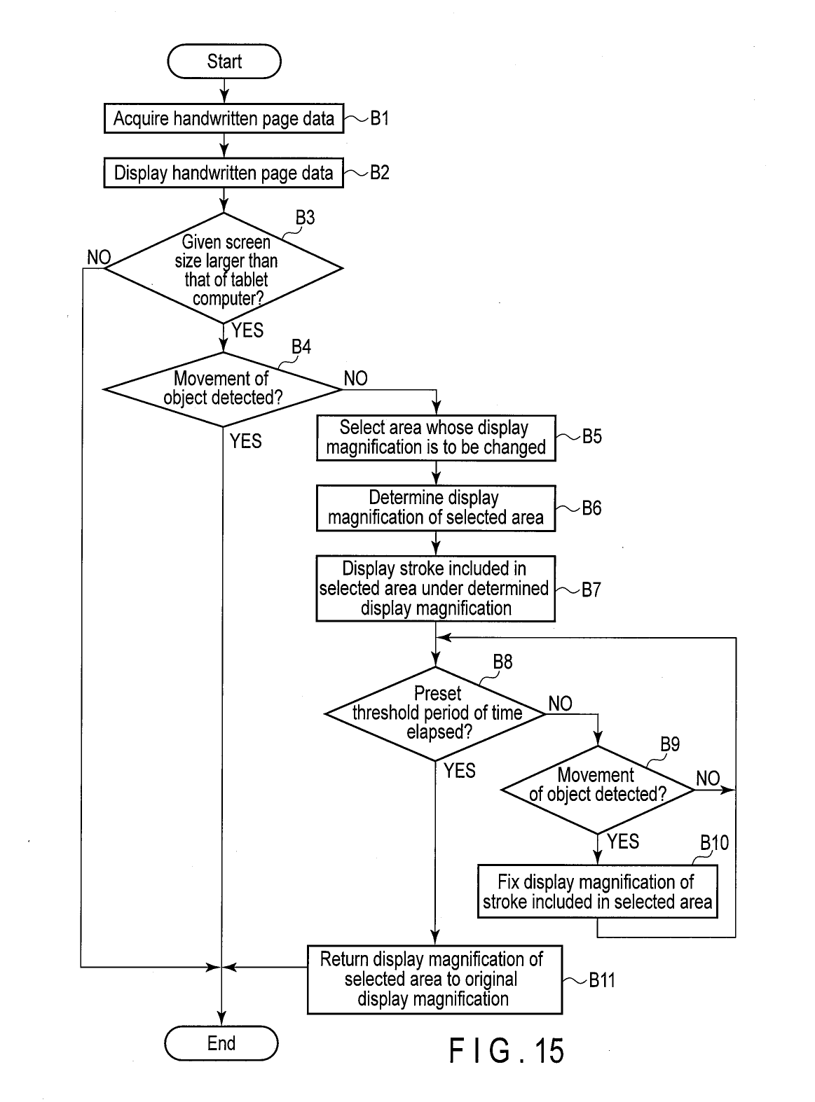

Next, the procedure of an enlargement display process to be performed by the handwritten note application program 202 will be described with reference to FIG. 15.

First, the page acquisition processor 301 acquires arbitrary handwritten page data from the storage medium 402. Then, the page acquisition processor 301 stores the acquired handwritten page data temporally in the work memory 401 and supplies it to the display processor 302 (block B1). The display processor 302 displays the handwritten page data on the screen (block B2).

When the digitizer 17C detects that the stylus 100 touches or hovers over the screen, the range selection module 303 acquires the currently-displayed handwritten page data from the work memory 401. The range selection module 303 also acquires screen size data indicative of the screen size of the tablet computer 10 from the OS 201. After that, the range selection module 303 determines whether the screen size indicated by the screen size data included in the acquired handwritten page data is larger than that of the tablet computer 10 (block B3).

When the range selection module 303 determines that the screen size indicated by the screen size data is not larger than that of the tablet computer 10 (No in block B3), the handwritten note application program 202 completes the enlargement display process.

When the range selection module 303 determines that the screen size indicated by the screen size data is larger than that of the tablet computer 10 (Yes in block B3), the range selection module 303 determines whether the digitizer 17C detects a movement of the stylus 100 (object) (block B4).

When the range selection module 303 determines that the digitizer 17C detects a movement of the stylus 100 (Yes in block B4), the handwritten note application program 202 completes the enlargement display process. However, as far as the handwritten page data is displayed on the screen, the process of block B4 is performed for each given period of time. More specifically, the process of block B4 is performed again while the handwritten page data is displayed on the screen. The process advances to block B5, which will be described later, when the range selection module 303 determines that the digitizer 17C does not detect a movement of the stylus 100 (No in block B4).

In block B5, the range selection module 303 selects a given rectangular area, the center of which corresponds to the tip of the stylus 100 detected by the digitizer 17C, as an area the display magnification of which is to be adjusted. The range selection module 303 may directly produce the area the display magnification of which is to be adjusted, according to user's handwriting operation.

The display magnification determination module 304 determines a display magnification of an area selected by the range selection module 303. More specifically, the display magnification determination module 304 determines a display magnification on the basis of the screen size data included in the handwritten page data acquired from the work memory 401 and the screen size data indicating the screen size of the tablet computer 10 (block B6).

The enlargement display module 305A of the enlargement display processor 305 enlarges a stroke corresponding to the stroke data included in the area selected by the range selection module 303 under the display magnification determined by the display magnification determination module 304 and displays it (block B7).

The enlargement display module 305A determines whether a preset threshold period of time has elapsed (block B8). When the enlargement display module 305A determines that a preset threshold period of time has elapsed (Yes in block B8), the process advances to block B11, which will be described later.

When the enlargement display module 305A determines that a preset threshold period of time has not elapsed (No in block B8), the enlargement display module 305A determines whether the digitizer 17C detects a movement of the stylus 100 (object) (block B9). When the enlargement display module 305A determines that the digitizer 17C does not detect a movement of the stylus 100 (No in block B9), the process returns to block B8.

When the enlargement display module 305A determines that the digitizer 17C detects a movement of the stylus 100 (Yes in block B9), it maintains the display magnification of the area selected by the range selection module 303 under the current display magnification (block B10), and the process returns to block B8.

Finally, the enlargement display module 305A returns the display magnification of the area selected by the range selection module 303 to the original magnification (block B11), and the handwritten note application program 202 completes the enlargement display process.

In the present embodiment, the page acquisition processor 301 acquires handwritten page data from the storage medium 402. However, it may be configured to acquire an image, such as a photo.

According to the embodiment described above, when a given portion of the reduced and displayed image (handwritten page data) is edited, the display magnification is adjusted on the basis of the screen size of a terminal (tablet computer) which created the image and the screen size of a terminal which displays the image, and the given portion of the image is zoomed in and displayed on the screen. Accordingly, a user is able to edit an image without using an operation technique, such as pinch-in and pinch-out.

The processes of the present embodiment may be executed by computer programs stored in a computer-readable storage medium. Thus, the same advantage as that of the present embodiment may be achieved only by installing the computer programs into an ordinary computer from the computer-readable storage medium.

The various modules of the systems described herein may be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of displaying an image on an electronic device comprising:
acquiring a first image created by a first device comprising a first screen of a first size; and
displaying the first image by the electronic device comprising a second screen of a second size different from the first size, the first image displayed on the second screen under a first magnification based on the first size and the second size.

2. The method of claim 1, wherein when the first image is edited by handwriting on the second screen, the first image is displayed on the second screen under the first magnification.

3. The method of claim 1, wherein the displaying comprises displaying the first image under the first magnification during a first period of time.

4. The method of claim 1, wherein when an object touches or hovers over the second screen, the first image is displayed on the second screen under the first magnification.

5. The method of claim 1, further comprising moving an area to be displayed under the first magnification according to a user's operation.

6. An electronic device, comprising:
a processor configured to acquire a first image created by a first device comprising a first screen of a first size; and
a display controller configured to display the first image by the electronic device, the electronic device comprising a second screen of a second size different from the first size, and the first image displayed on the second screen under a first magnification based on the first size and the second size.

7. The electronic device of claim 6, wherein when the first image is edited by handwriting on the second screen, the display controller is configured to display the first image on the second screen under the first magnification.

8. The electronic device of claim 6, wherein the display controller is configured to display the first image under the first magnification during a first period of time.

9. The electronic device of claim 6, wherein when an object touches or hovers over the second screen, the display controller is configured to display the first image on the second screen under the first magnification.

10. The electronic device of claim 6, further comprising a controller configured to move an area to be displayed under the first magnification according to a user's operation.

11. A non-transitory computer-readable storage medium storing computer-executable instructions that, when executed, cause a computer to:
acquire a first image created by a first device comprising a first screen of a first size; and
display the first image by a second device comprising a second screen of a second size different from the first size, the first image displayed on the second screen under a first magnification based on the first size and the second size.

12. The storage medium of claim 11, wherein when the first image is edited by handwriting on the second screen, the first image is displayed on the second screen under the first magnification.

13. The storage medium of claim 11, wherein the first image is displayed under the first magnification during a first period of time.

14. The storage medium of claim 11, wherein when an object touches or hovers over the second screen, the first image is displayed on the second screen under the first magnification.

15. The storage medium of claim 11, wherein an area to be displayed under the first display magnification is configured to be moved according to a user's operation.
